(19) United States
(12) Patent Application Publication
(10) Pub. No.: US 2023/0386441 A1
(43) Pub. Date: Nov. 30, 2023

(54) ELECTRONIC MUSICAL INSTRUMENT, KEY SCANNING METHOD AND NON-TRANSITORY COMPUTER READABLE MEDIUM

(71) Applicant: Roland Corporation, Shizuoka (JP)

(72) Inventors: Keigo Tsutaki, Shizuoka (JP); Takahiro Murai, Shizuoka (JP)

(73) Assignee: Roland Corporation, Shizuoka (JP)

(21) Appl. No.: 18/314,787

(22) Filed: May 9, 2023

(30) Foreign Application Priority Data
May 31, 2022 (JP) 2022-088146

(51) Int. Cl. G10H 1/18

(52) U.S. Cl. CPC G10H 1/182; G10H 2220/221; G10H 2220/275

(57) ABSTRACT

An electronic musical instrument includes: a plurality of keys; a detection part, detecting, by a plurality of detectors provided for each of the keys, a state of depression or release of the key; a musical tone controller, controlling a musical tone according to the state of the key detected by the detection part; a scanning part, sequentially executing detection of the state of the key by the detection part for each of the keys; an operation key acquisition part, acquiring the key that is in the middle of being depressed or being released based on a detection result obtained by the detection part; and a priority part, giving priority to the detection of the state of the key acquired by the operation key acquisition part by the detection part in the scanning part.

### CROSS-REFERENCE TO RELATED APPLICATION

This application claims the priority benefit of Japan Application No. 2022-088146, filed on May 31, 2022. The entirety of the above-mentioned patent application is hereby incorporated by reference herein and made a part of this specification.

### BACKGROUND

### Technical Field

The present disclosure relates to an electronic musical instrument, a key scanning method and a key scanning program.

### Related Art

Patent Document 1 (Japanese Patent Laid-Open No. 2016-57374) discloses an electronic keyboard instrument in which first to fourth key switch groups 41-44 are provided for each of a plurality of white keys 31w and black keys 31b (hereinafter abbreviated as “keys”), and sound production or velocity is controlled according to an on/off state of the first to fourth key switch groups 41-44. The first to fourth key switch groups 41-44 are arranged so as to turn on in order when each key is depressed. The plurality of keys are divided into 15 blocks according to a scale corresponding to the keys, and a state of the first to fourth key switch groups 41-44 is sequentially acquired block by block.

Specifically, first, the state of the first and second key switch groups 41, 42 of each block is acquired. In the case where both the first and second key switch groups 41, 42 of a certain key have turned on, after a time difference between a time when the first key switch group 41 of the key turned on and a time when the second key switch group 42 turned on has further elapsed, acquisition of the state of the third and fourth key switch groups 43, 44 of a block to which the key belongs is started. Accordingly, since a state of a depressed or released key can be acquired without always acquiring the state of the first to fourth key switch groups 41-44 of all the keys, processing load of the electronic keyboard instrument can be reduced.

However, in Patent Document 1, a time lag corresponding to the above time difference is required from when the first and second key switch groups 41, 42 turn on until when acquisition of the state of the third and fourth key switch groups 43, 44 is started. Accordingly, immediately after the first and second key switch groups 41, 42 turn on, a time lag occurs between acquisition of the state of the first and second key switch groups 41, 42 and acquisition of the state of the third and fourth key switch groups 43, 44. Accordingly, since a velocity calculated according to a timing at which the first to fourth key switch groups 41-44 turn on is calculated to be slower than a speed at which the key is actually depressed, there is a possibility that a user who plays the electronic keyboard instrument may have a feeling of incongruity on a musical tone output according to the velocity.

### SUMMARY

The present disclosure provides an electronic musical instrument, a key scanning method and a key scanning program in which a musical tone can be output with a reduced feeling of incongruity while the number of times of key state detection is minimized.

An electronic musical instrument of the present disclosure includes: a plurality of keys; a detection part, detecting, by a plurality of detectors provided for each of the keys, a state of depression or release of the key; a musical tone controller, controlling a musical tone according to the state of the key detected by the detection part; a scanning part, sequentially executing detection of the state of the key by the detection part for each of the keys; an operation key acquisition part, acquiring the key that is in the middle of being depressed or being released based on a detection result obtained by the detection part; and a priority part, giving priority to the detection of the state of the key acquired by the operation key acquisition part by the detection part in the scanning part.

A key scanning method of the present disclosure is a method executed by an electronic musical instrument provided with a plurality of keys and a plurality of detectors provided for each of the keys. The key scanning method includes: a detection step of detecting a state of depression or release of the key by the detector; a musical tone control step of controlling a musical tone according to the state of the key detected by the detection step; a scanning step of sequentially executing detection of the state of the key by the detection step for each of the keys; an operation key acquisition step of acquiring the key that is in the middle of being depressed or being released based on a detection result obtained by the detection step; and a priority step of giving priority to the detection of the state of the key acquired by the operation key acquisition step by the detection step in the scanning step.

A non-transitory computer readable medium, storing a key scanning program causing a computer provided with a keyboard that includes a plurality of keys and a plurality of detectors provided for each of the keys to execute processing for sequentially detecting a state of the key. The key scanning program causes the computer to execute: a detection step of detecting a state of depression or release of the key by the detector; a musical tone control step of controlling a musical tone according to the state of the key detected by the detection step; a scanning step of sequentially executing detection of the state of the key by the detection step for each of the keys; an operation key acquisition step of acquiring the key that is in the middle of being depressed or being released based on a detection result obtained by the detection step; and a priority step of giving priority to the detection of the state of the key acquired by the operation key acquisition step by the detection step in the scanning step.

### BRIEF DESCRIPTION OF THE DRAWINGS

FIG. 1 is a front perspective view of an electronic piano.

FIG. 2 is a sectional view of the electronic piano of FIG. 1 along line II-II.

FIG. 3 is a partially enlarged sectional view of the electronic piano of FIG. 2 in which a portion III is enlarged.

(a) of FIG. 4 schematically illustrates a scan line, and (b) of FIG. 4 schematically illustrates time slot data.

(a) of FIG. 5 schematically illustrates a scan order in the case where no priority line is set, (b) of FIG. 5 schematically illustrates a scan order in the case where only a first priority line is set, and (c) of FIG. 5 schematically illustrates a scan order in the case where a first priority line and a second priority line are set.

FIG. 6 is a functional block diagram of an electronic piano.

FIG. 7 is a block diagram illustrating an electrical configuration of an electronic piano.

(a) of FIG. 8 is a flowchart of main processing, (b) of FIG. 8 is a flowchart of normal scanning processing, and (c) of FIG. 8 is a flowchart of velocity processing.

FIG. 9 is a flowchart of single priority scanning processing.

FIG. 10 is a flowchart of multiple priority scanning processing.

(a) of FIG. 11 is a flowchart of first priority line change processing, (b) of FIG. 11 is a flowchart of second priority line change processing, and (c) of FIG. 11 is a flowchart of other line change processing.

### DESCRIPTION OF THE EMBODIMENTS

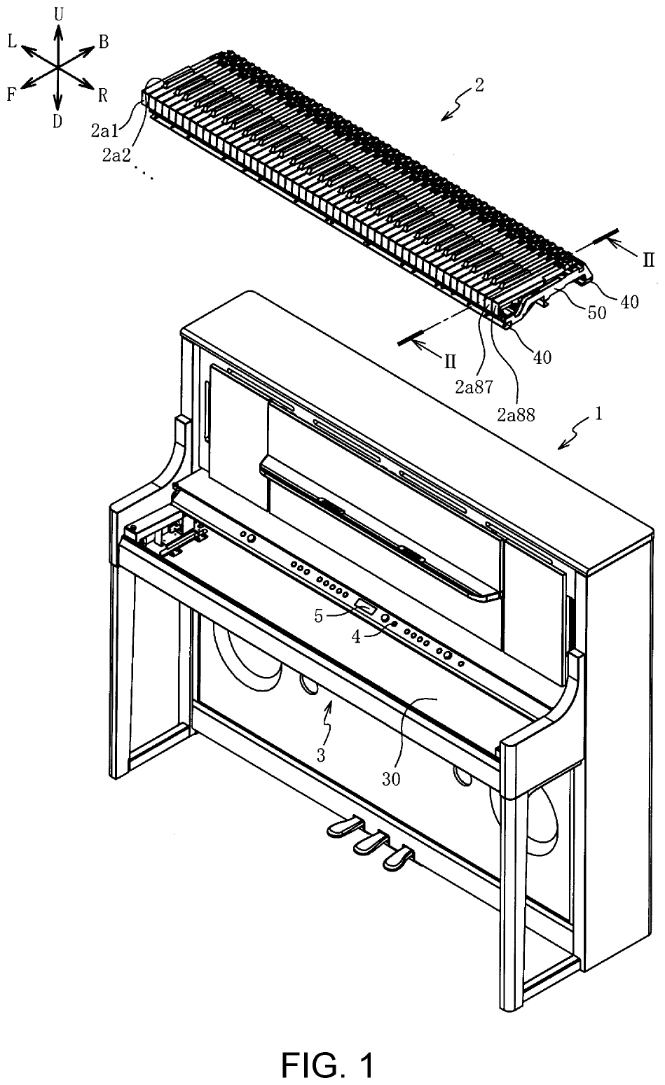

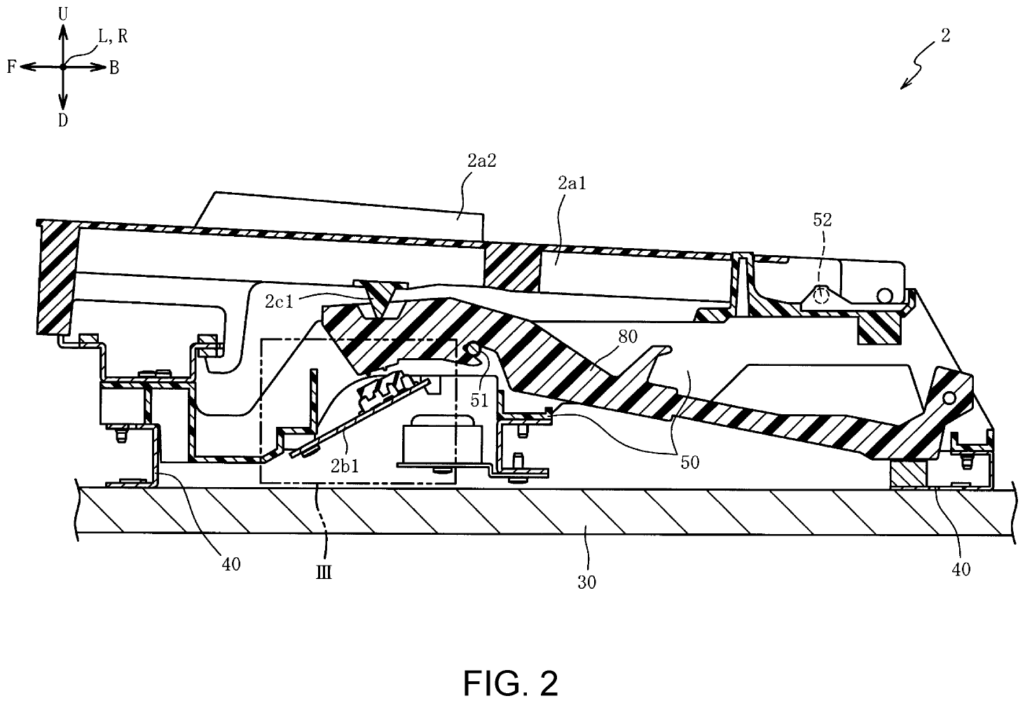

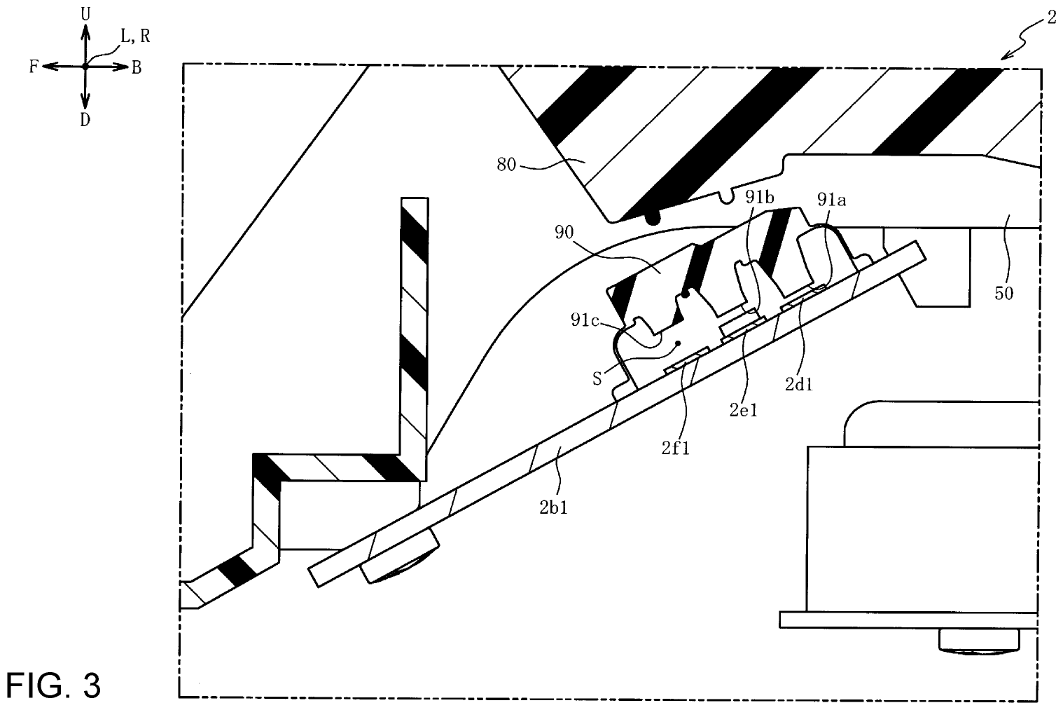

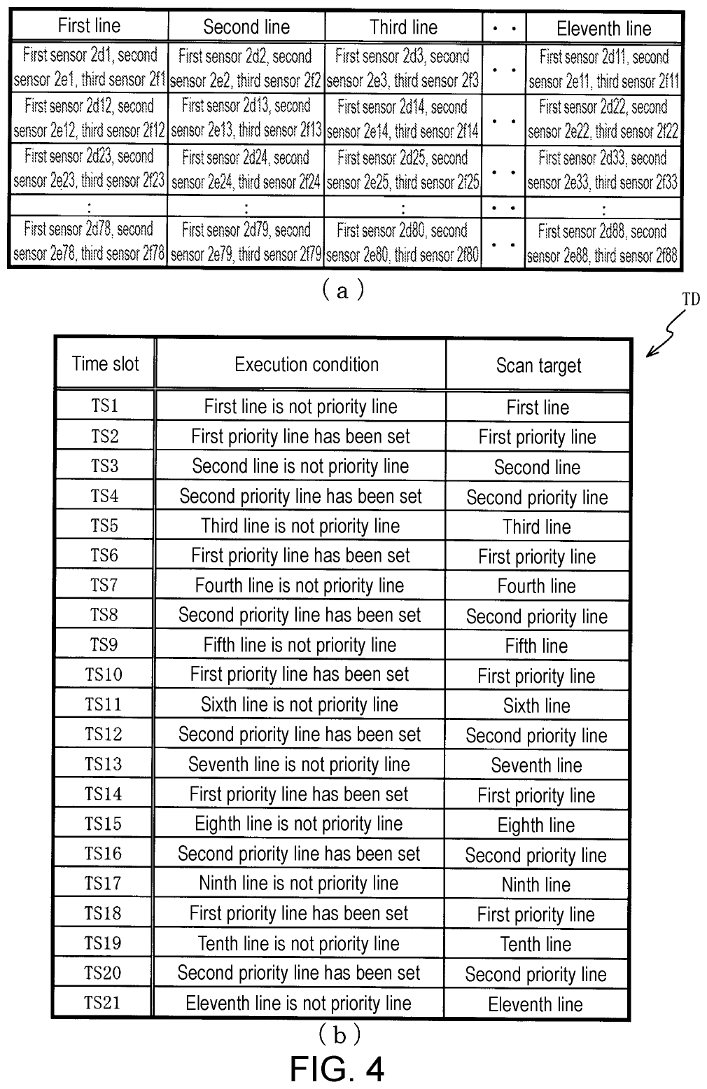

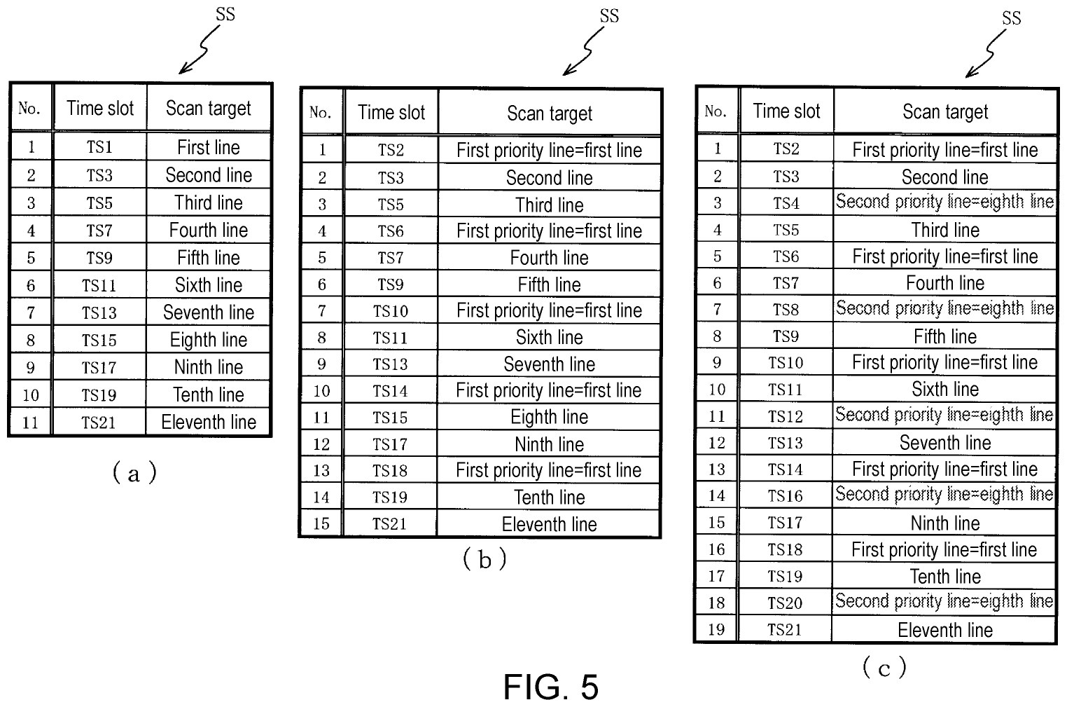

Hereinafter, embodiments will be described with reference to the accompanying drawings. First, an overview of an electronic piano 1 of the present embodiment is described with reference to FIG. 1. FIG. 1 is a front perspective view of the electronic piano 1. FIG. 1 illustrates a state in which a keyboard 2 has been removed from a keyboard table 30. In FIG. 1, directions of arrow U, arrow D, arrow F, arrow B, arrow L, and arrow R respectively indicate upward, downward, forward, rearward, leftward, and rightward directions relative to the electronic piano 1. The same applies to FIG. 2 and FIG. 3.

The electronic piano 1 is an electronic musical instrument that produces a musical tone based on a performance of a user H, or a musical tone based on music data conforming to the Musical Instrument Digital Interface (MIDI) standard. As illustrated in FIG. 1, the electronic piano 1 is mainly provided with the keyboard 2, the keyboard table 30 supporting the keyboard 2, a setting key 4 for performing various settings of the electronic piano 1, and an LCD 5 displaying a setting state of the various settings or the like.

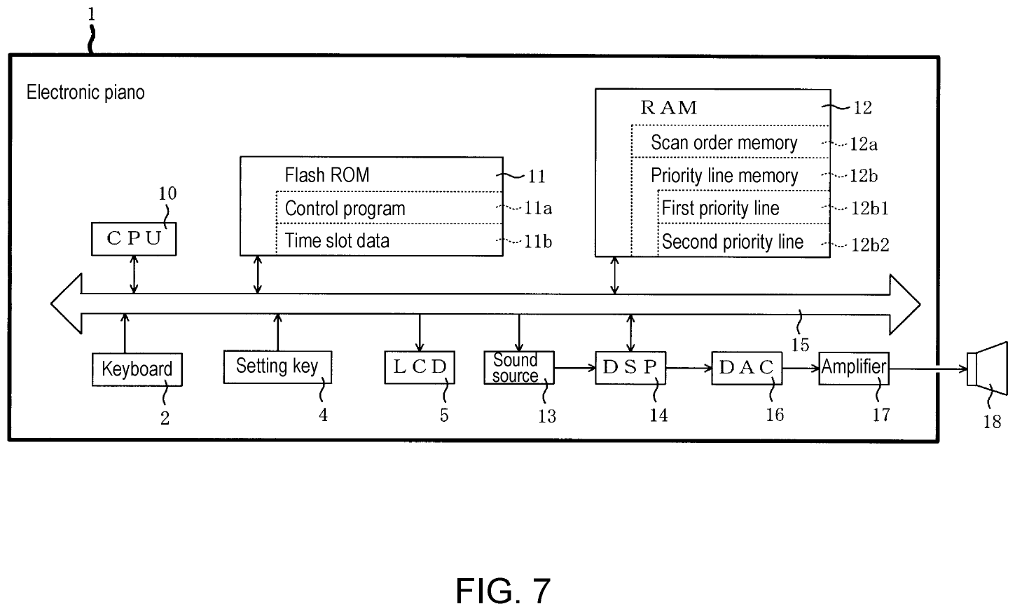

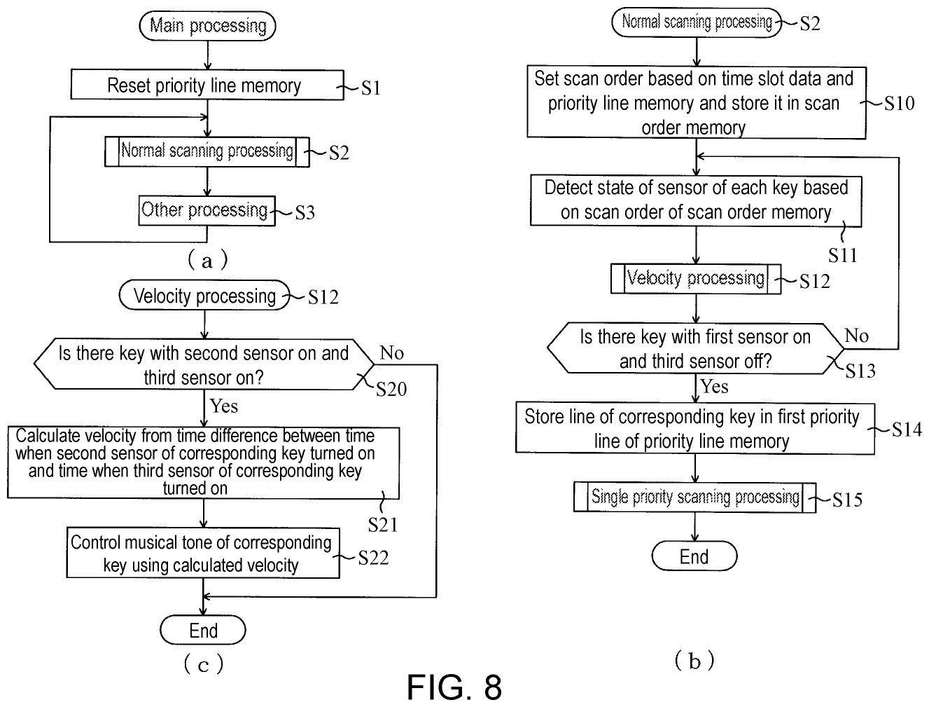

The keyboard 2 is an input device for acquiring performance information according to the performance of the user H. The keyboard 2 is provided with a pair of support members 40 for fixing the keyboard 2 to the keyboard table 30, a base member 50 supported by the pair of support members 40, and keys 2a1 to 2a88 supported by the base member 50. The performance information conforming to the MIDI standard, which corresponds to depression or release of the keys 2a1 to 2a88 by the user H, is output to a CPU 10 (see FIG. 7) and is output as a musical tone.

The support member 40 is provided on the front and rear sides of the keyboard 2. Each of front and rear end portions of the base member 50 is fixed to the support member 40. The keys 2a1 to 2a88 are supported on an upper surface of the base member 50.

Next, a detailed configuration of the electronic piano 1 is described with reference to FIG. 2 and FIG. 3. FIG. 2 is a sectional view of the electronic piano 1 of FIG. 1 along line II-II. FIG. 3 is a partially enlarged sectional view of the electronic piano 1 of FIG. 2 in which a portion III is enlarged. A structure rotatably axially supporting (supporting) the keys 2a1 to 2a88 by the base member 50, a structure guiding rotation of the keys 2a1 to 2a88, and a structure detecting depression or release of the keys 2a1 to 2a88 are substantially the same in the keys 2a1 to 2a88. Thus, in the following, only the structure in the key 2a1 will be described, and the structure of the keys 2a2 to 2a88 will be omitted.

As illustrated in FIG. 2, the electronic piano 1 is provided with a hammer 80 axially supported to be rotatable about a rotating shaft 51 of the base member 50, and a substrate 2b1 on which a first sensor 2d1 or the like described later is provided that detects a state of depression or release of the key 2a1 from a rotation state of the hammer 80.

A rear end portion of the key 2a1 is axially supported on an upper surface of a rear end side of the base member 50 to be rotatable about a rotating shaft 52. A protrusion 2c1 protruding downward is formed from a lower surface of a substantially central portion of the key 2a1 in the front-rear direction. The protrusion 2c1 is a portion for transmitting a rotational force associated with rotation of the key 2a1 to the hammer 80, and a tip of the protrusion 2c1 is brought into contact with the hammer 80.

The hammer 80 has a mass for giving a feel of key depression when the key 2a1 is depressed. The hammer 80 is axially supported by the rotating shaft 51 located on the rear side of a portion where the hammer 80 and the protrusion 2c1 contact. When the key 2a1 is depressed, the protrusion 2c1 of the key 2a1 slides along an upper surface of the hammer 80, thereby causing the hammer 80 to rotate about the rotating shaft 51. Due to a reaction force associated with the rotation of the hammer 80, the user H is given a feel upon depression of the key 2a1. When the key 2a1 is depressed, by detecting an acceleration of rotation of the hammer 80 by the first sensor 2d1 or the like on the substrate 2b1, key depression information at the time of key depression is detected.

As illustrated in FIG. 3, the substrate 2b1 is provided with a cover 90, and the first sensor 2d1, a second sensor 2e1 and a third sensor 2f1 arranged on an upper surface of the substrate 2b1. The first sensor 2d1, the second sensor 2e1 and the third sensor 2f1 are each a sensor for detecting depression or release of the key 2a1. The cover 90 has a space S in which the first sensor 2d1 and so on are accommodated, and the cover 90 is fixed to the substrate 2b1 while covering the first sensor 2d1 and so on.

Movable contacts 91a, 91b, and 91c are provided on an inner surface of the cover 90. The movable contact 91a is provided on the cover 90 so as to correspond to the first sensor 2d1, the movable contact 91b is provided on the cover 90 so as to correspond to the second sensor 2e1, and the movable contact 91c is provided on the cover 90 so as to correspond to the third sensor 2f1.

Furthermore, the first sensor 2d1, the second sensor 2e1, the third sensor 2f1 and the movable contacts 91a to 91c are arranged so that, in the case where the key 2a1 in a released state is depressed, the first sensor 2d1 and the movable contact 91a make contact first, then the second sensor 2e1 and the movable contact 91b make contact, and the third sensor 2f1 and the movable contact 91c make contact last.

In the case where the first sensor 2d1 and the movable contact 91a are in contact, the first sensor 2d1 is detected to be on; in the case where the contact between them is released, the first sensor 2d1 is detected to be off. Similarly, in the case where the second sensor 2e1 and the movable contact 91b are in contact, the second sensor 2e1 is detected to be on; in the case where the contact between them is released, the second sensor 2e1 is detected to be off. In the case where the third sensor 2f1 and the movable contact 91c are in contact, the third sensor 2f1 is detected to be on; in the case where the contact between them is released, the third sensor 2f1 is detected to be off. According to a timing at which the first sensor 2d1 to the third sensor 2f1 turn on or off, a state of depression or release or in the middle of depression or in the middle of release of the key 2a1 is detected, and a musical tone corresponding to the key 2a1 is controlled according to the detected state.

Hereinafter, the keys 2a1 to 2a88 are referred to as “key 2aX” when no distinction is made between them, and the first sensors 2d1 to 2d88 are referred to as “first sensor 2dX” when no distinction is made between them. Similarly, the second sensors 2e1 to 2e88 are referred to as “second sensor 2eX” when no distinction is made between them, and the third sensors 2f1 to 2f88 are referred to as “third sensor 2fX” when no distinction is made between them. Furthermore, the first sensor 2dX, the second sensor 2eX and the third sensor 2fX are collectively abbreviated as “sensors 2dX to 2fX” or the like.

The on/off state of the first sensors 2d1 to 2d88 respectively corresponding to the keys 2a1 to 2a88 is detected on a regular basis, and the on/off state detected is used in control of musical tones corresponding to the keys 2a1 to 2a88. A detection method of the first sensors 2d1 to 2d88 of the present embodiment is described with reference to FIG. 4 and FIG. 5.

(a) of FIG. 4 schematically illustrates a scan line. In the present embodiment, the first sensors 2d1 to 2d88, the second sensors 2e1 to 2e88 and the third sensors 2f1 to 2f88 respectively corresponding to the keys 2a1 to 2a88 are divided into 11 “scan lines” including a first line to an eleventh line. For each scan line, the state of the sensors 2dX to 2fX belonging to the scan line is sequentially detected.

Specifically, as illustrated in (a) of FIG. 4, the sensors 2d1 to 2f1, 2d12 to 2f12, 2d23 to 2f23, . . . , 2d67 to 2f67, and 2d78 to 2f78, which correspond to 8 keys 2aX including the keys 2a1, 2a12, 2a23, . . . , 2a67, and 2a78, are set to the first line. The sensors 2d2 to 2f2, 2d13 to 2f13, . . . , and 2d79 to 2f79, which correspond to 8 keys 2aX including the keys 2a2, 2a13, . . . , and 2a79, are set to the second line. The third to eleventh lines are set in the same manner thereafter.

The first to eleventh lines set in this manner are sequentially switched, and the on/off state of the sensors 2dX to 2fX belonging to the scan line is detected. Specifically, the scan lines are switched in order from the first line, the second line, the third line, . . . , to the eleventh line, and the on/off state of the sensors 2dX to 2fX of the key 2aX belonging to each scan line is detected. When detection of the on/off state of the sensors 2dX to 2fX of the eleventh line is completed, detection of the on/off state of the sensors 2dX to 2fX of the first line is started again. Hereinafter, detection of the on/off state of the sensors 2dX to 2fX belonging to a scan line (such as the first line) is simply referred to as “detection of a scan line (such as the first line)”.

In this way, by dividing 88 keys 2aX into 11 scan lines of 8 keys 2aX each, and detecting the on/off state of the sensors 2dX to 2fX collectively for each scan line, compared to a case of detecting the sensors 2dX to 2fX corresponding to 88 keys 2a sequentially for each key 2a, the frequency (number of times) of detection of the on/off state of the sensors 2dX to 2fX per unit time can be increased.

By providing, for each scan line, a control device (not illustrated) that detects the state of the sensors 2dX to 2fX of the key 2aX belonging to the scan line, and connecting the control device to the CPU 10 described later in FIG. 7, there is no need to connect to the CPU 10 a signal line through which the on/off state from all the sensors 2dX to 2fX is communicated. That is, there is no need to connect 264 signal lines to the CPU 10. Accordingly, a circuit board (not illustrated) on which the CPU 10 is mounted can be formed compactly, and manufacturing cost of the electronic piano 1 can thus be reduced.

Each scan line is composed of discrete keys 2aX rather than consecutive keys 2aX (for example, key 2a1, key 2a2, key 2a3, . . . ) in a specific range in the keyboard 2, so that the first line is set by the sensors 2dX to 2fX corresponding to the keys 2a1, 2a12, 2a23, . . . , 2a67, and 2a78, and the second line is set by the sensors 2dX to 2fX corresponding to the keys 2a2, 2a13, . . . , and 2a79.

Thus, it can be prevented that only the keys 2aX in a specific range on the keyboard 2 are detected by detection of one scan line, and the keys 2aX in a wide range on the keyboard 2 can be detected. Accordingly, since the state of the sensors 2dX to 2fX can be detected with good response according to performance and operation of the key 2aX by the user H, the feeling of incongruity on the musical tone output according to such performance and operation can be reduced.

In such detection of each scan line, priority is further given to detection of a scan line to which the key 2aX that is in the middle of being depressed or being released belongs. A method for giving priority to detection of a scan line is described with reference to (b) of FIG. 4 and FIG. 5.

(b) of FIG. 4 schematically illustrates time slot data TD. In the present embodiment, the order of scan lines in which detection is performed is managed in the time slot data TD. In the time slot data TD, a time slot number (TS1 to TS21) representing the order in which detection is performed, a scan target being a scan line detected in the time slot, and an execution condition being a condition for whether to perform detection of the scan target are set.

In addition to the first to eleventh lines described above, a priority line is set as the scan target. In the present embodiment, the term “priority line” refers to a scan line to which the key 2aX that is in the middle of being depressed or being released belongs. In the present embodiment, two priority lines including a first priority line L1 and a second priority line L2 are provided as the priority line.

In the time slot data TD, the first to eleventh lines are set in the order of the first line to the eleventh line, and the first priority line L1 and the second priority line L2 are inserted between each of the first to eleventh lines. Specifically, the first to eleventh lines are set in the time slots TS1, TS3, TS5, TS7, TS9, TS11, TS13, TS15, TS17, TS19, and TS21, respectively. The first priority line L1 is set in the time slots TS2, TS6, TS10, TS14 and TS18, and the second priority line L2 is set in the time slots TS4, TS8, TS12, TS16, and TS20.

That is, in the time slot data TD, the first priority line L1 is inserted between the first line and the second line, between the third line and the fourth line, . . . , and between the ninth line and the tenth line. In the time slot data TD, the second priority line L2 is inserted between the second line and the third line, between the fourth line and the fifth line, . . . , and between the tenth line and the eleventh line.

In the time slot data TD, by presetting a position (insertion position) where the first priority line L1 and the second priority line L2 are inserted between the first line and the eleventh line, the insertion of the first priority line L1 or the second priority line L2 with respect to a scan order SS described later can be facilitated.

In this way, whether to perform detection of the first to eleventh lines and scan lines corresponding to the first priority line L1 and the second priority line L2 set in each time slot in the time slot data TD is determined by whether the execution condition set for each time slot is met.

In the execution condition corresponding to the first priority line L1 or the second priority line L2, it is set whether any one of the first to eleventh lines has been set as the first priority line L1 or the second priority line L2. Here, in the present embodiment, for the first priority line L1 or the second priority line L2, a scan line to which any key 2aX belongs is in the middle of being depressed or being released is set. On the other hand, in the execution condition corresponding to the first to eleventh lines, it is set whether each is not set as either the first priority line L1 or the second priority line L2.

By executing detection of a scan line of a time slot that meets the execution condition set for each time slot while omitting detection of a scan line of a time slot that does not meet the execution condition, the scan order SS is set in which the order of scan lines in which detection of the scan line is actually performed. The scan order SS is described with reference to FIG. 5.

(a) of FIG. 5 schematically illustrates the scan order SS in the case where no priority line is set, (b) of FIG. 5 schematically illustrates the scan order SS in the case where only the first priority line L1 is set, and (c) of FIG. 5 schematically illustrates the scan order SS in the case where the first priority line L1 and the second priority line L2 are set.

In the scan order SS, a time slot meeting the execution condition and a scan target thereof in the time slot data TD are set. As illustrated in (a) of FIG. 5, in the case where none of the priority lines is set, the scan order SS is set in which the time slots corresponding to the first priority line L1 and the second priority line L2 are deleted from each time slot in the time slot data TD.

As illustrated in (b) of FIG. 5, in the case where the first line is set only as the first priority line L1 among the priority lines, the scan order SS is set in which the time slot corresponding to the second priority line L2 that is not set and the first line (time slot TS1) set as the first priority line L1 is deleted from the scan target in the time slot data TD, and the first line is set as the first priority line L1.

As illustrated in (c) of FIG. 5, in the case where the first line and the eighth line have been set respectively as the first priority line L1 and the second priority line L2, the scan order SS is set in which the first line (time slot TS1) set as the first priority line L1 and the eighth line (time slot TS15) set as the second priority line L2 are deleted from the time slot data TD, and the first line and the eighth line are set respectively as the first priority line L1 and the second priority line L2.

Detection of the scan line in the scan order SS set in this way is sequentially performed from the top (No. 1) scan line in the scan order SS, and detection of the scan line is repeatedly performed based on the scan order SS.

As illustrated in (b) and (c) of FIG. 5, the scan line to which the key 2aX that is in the middle of being depressed or being released belongs is set as the priority line, and the set priority line is inserted into the scan order SS. Accordingly, in one detection of the scan line based on the scan order SS, since the detection of the scan line to which the key 2aX that is in the middle of being depressed or being released belongs is performed multiple times, the frequency of detection of the key 2aX that is in the middle of being depressed or being released can be increased. Accordingly, since a musical tone corresponding to the key 2aX can be controlled in detail, the feeling of incongruity of the user H on the musical tone can be reduced. Since only the priority line is inserted into the scan order SS, an increase in the number of times of detection of the key 2aX can be minimized.

In the scan order SS of (b) FIG. 5, while the first priority line L1 is inserted, the time slot TS1 corresponding to the first line set as the first priority line L1 is deleted. Accordingly, detection of the first line by the time slot TS1 and detection of the first line that has become the first priority line L1 by the time slot TS2 will not be consecutively executed.

Similarly, in the scan order SS of (c) of FIG. 5, while the first priority line L1 and the second priority line L2 are inserted, the time slot TS1 corresponding to the first line set as the first priority line L1 and the time slot TS15 corresponding to the eighth line set as the second priority line L2 is deleted. Accordingly, detection of the first line by the time slot TS1 and detection of the first line that has become the first priority line L1 by the time slot TS2 will not be consecutively executed, and detection of the eighth line by the time slot TS15 and detection of the eighth line that has become the second priority line L2 by the time slot TS16 will not be consecutively executed.

Thus, the frequency of detection of a priority line in one scan order SS can be increased, and a certain amount of time interval is provided between detection of a certain priority line and detection of a subsequent priority line. Thus, the on/off state of the sensors 2dX to 2fX belonging to the priority line can be efficiently detected.

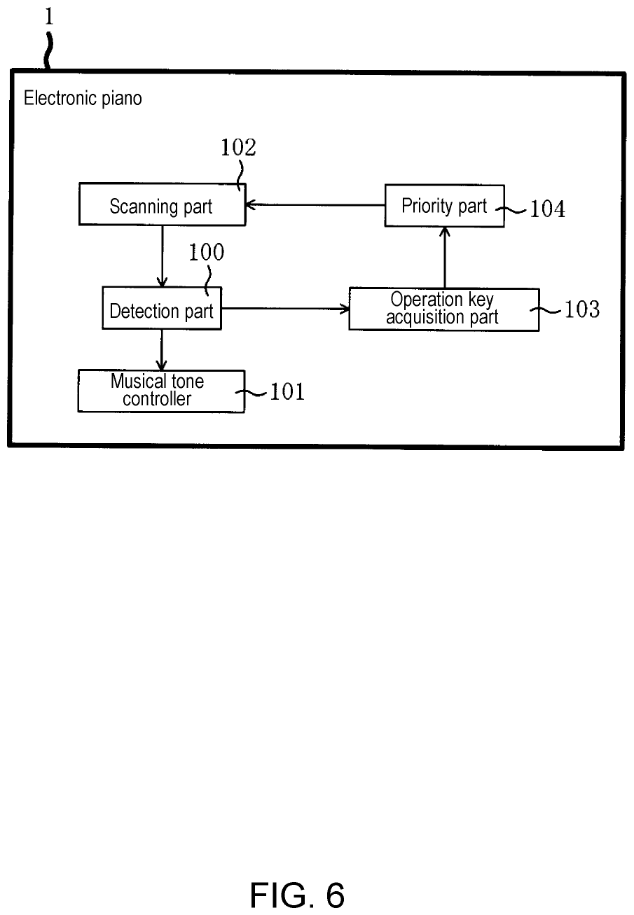

Next, a function of the electronic piano 1 is described with reference to FIG. 6. FIG. 6 is a functional block diagram of the electronic piano 1. As illustrated in FIG. 6, the electronic piano 1 includes a detection part 100, a musical tone controller 101, a scanning part 102, an operation key acquisition part 103, and a priority part 104.

The detection part 100 is a means of detecting a state of depression or release of the key 2aX by a plurality of sensors 2dX to 2fX provided for each key 2aX, and is implemented by the CPU 10 described later in FIG. 7. The musical tone controller 101 is a means of controlling a musical tone according to the state of the key 2aX detected by the detection part 100. The scanning part 102 is a means of sequentially executing detection of the state of the key 2aX by the detection part 100 for each key 2aX. Each of the musical tone controller 101 and the scanning part 102 is implemented by the CPU 10.

The operation key acquisition part 103 is a means of acquiring the key 2aX that is in the middle of being depressed or being released based on a detection result obtained by the detection part 100. The priority part 104 is a means of giving priority to detection of the state of the key 2aX acquired by the operation key acquisition part 103 by the detection part 100 in the scanning part 102. Each of the operation key acquisition part 103 and the priority part 104 is implemented by the CPU 10.

The operation key acquisition part 103 acquires the key 2aX that is in the middle of being depressed or being released. In the detection of the state by the detection part 100 that is sequentially executed in the scanning part 102, priority is given to the detection of the state of the key 2aX that is in the middle of being depressed or being released. Thus, while an increase in detection of the key 2aX by the detection part 100 is minimized, the frequency of detection of the state of the key 2aX whose musical tone may vary in the middle of being depressed or being released can be increased. Accordingly, a musical tone to be output can be controlled in detail, and the feeling of incongruity of the user H on the musical tone can be reduced.

Next, an electrical configuration of the electronic piano 1 is described with reference to FIG. 7. FIG. 7 is a block diagram illustrating an electrical configuration of the electronic piano 1. As illustrated in FIG. 7, the electronic piano 1 includes the CPU 10, a flash ROM 11, a RAM 12, the keyboard 2, the setting key 4, the LCD 5, a sound source 13, and a digital signal processor 14 (hereinafter referred to as “DSP 14”), each of which is connected via a bus line 15.

The CPU 10 is an arithmetic unit that controls each part connected by the bus line 15. The flash ROM 11 is a rewritable non-volatile storage device storing programs executed by the CPU 10 or fixed value data or the like, and the flash ROM 11 includes a control program 11a, and time slot data 11b in which the time slot data TD is stored. When the control program 11a is executed by the CPU 10, main processing of (a) of FIG. 8 is executed.

The RAM 12 is a memory for rewritably storing various work data or flags or the like when the CPU 10 executes a program, and the RAM 12 includes a scan order memory 12a storing the scan order SS and a priority line memory 12b storing a priority line. The priority line memory 12b includes a first priority line 12b1 storing the first priority line L1 and a second priority line 12b2 storing the second priority line L2.

The sound source 13 is a device that outputs waveform data based on input performance information. The DSP 14 is an arithmetic unit for arithmetically processing the waveform data input from the sound source 13. A digital-to-analog converter (DAC) 16 is connected to the DSP 14, an amplifier 17 is connected to the DAC 16, and a speaker 18 is connected to the amplifier 17.

Next, processing executed by the CPU 10 of the electronic piano 1 is described with reference to FIG. 8 to FIG. 11. (a) of FIG. 8 is a flowchart of the main processing. The main processing is processing executed in the case where the electronic piano 1 is powered on. In the main processing, first, by rendering the first priority line 12b1 and the second priority line 12b2 of the priority line memory 12b not set, the priority line memory 12b is reset (S1).

After the processing of S1, normal scanning processing (S2) described later is executed, and after the normal scanning processing, other processing (S3) of the electronic piano 1 is executed. The processing of S2 onward is repeated. The processing performed in S3 includes, for example, changing a timbre of a musical tone to be output according to an instruction from the user H via the setting key 4 (see FIG. 1). Here, the normal scanning processing is described with reference to (b) of FIG. 8.

(b) of FIG. 8 is a flowchart of the normal scanning processing. In the normal scanning processing, first, the scan order SS is set based on the time slot data TD of the time slot data 11b and the priority line memory 12b, and is stored in the scan order memory 12a (S10). In the processing of S10, since the first priority line 12b1 and the second priority line 12b2 of the priority line memory 12b are not set, the scan order SS in which the time slots of the first priority line L1 and the second priority line L2 are deleted from the time slot data TD, as illustrated in (a) of FIG. 5, is stored in the scan order memory 12a.

After the processing of S10, the state of the sensors 2dX to 2fX of each key 2aX is detected based on the scan order SS of the scan order memory 12a (S11). After the processing of S11, velocity processing (S12) is executed. Here, the velocity processing is described with reference to (c) of FIG. 8.

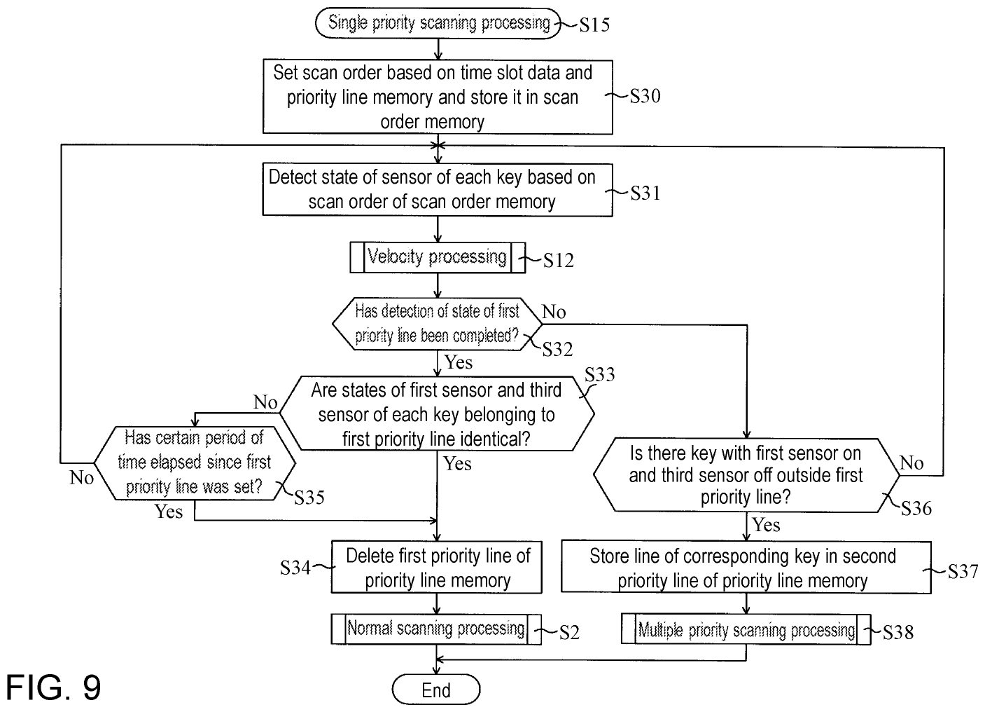

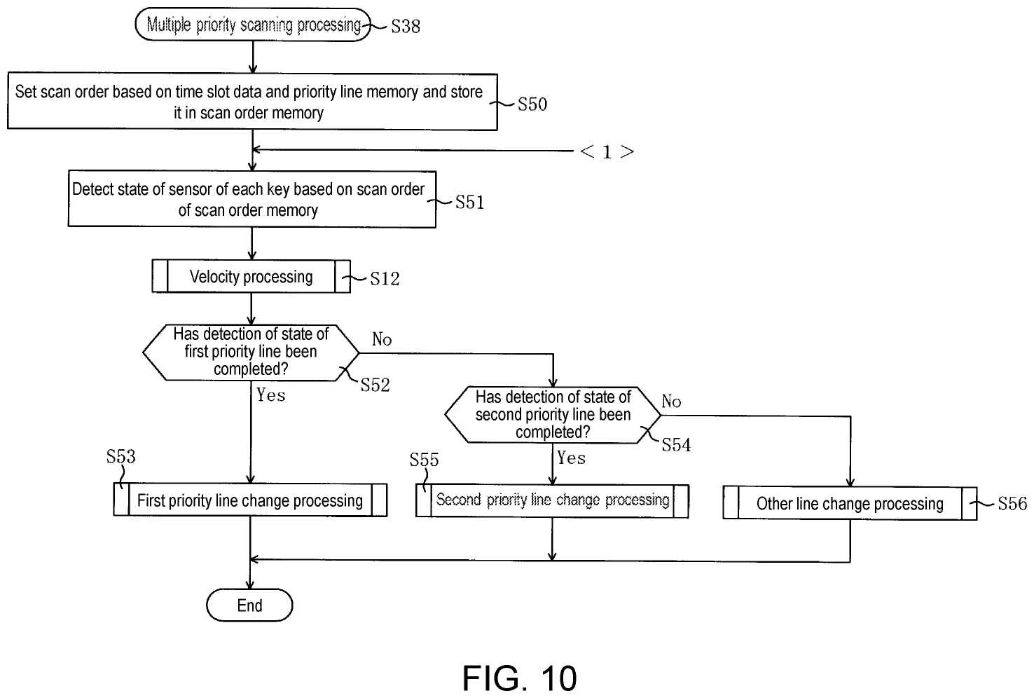

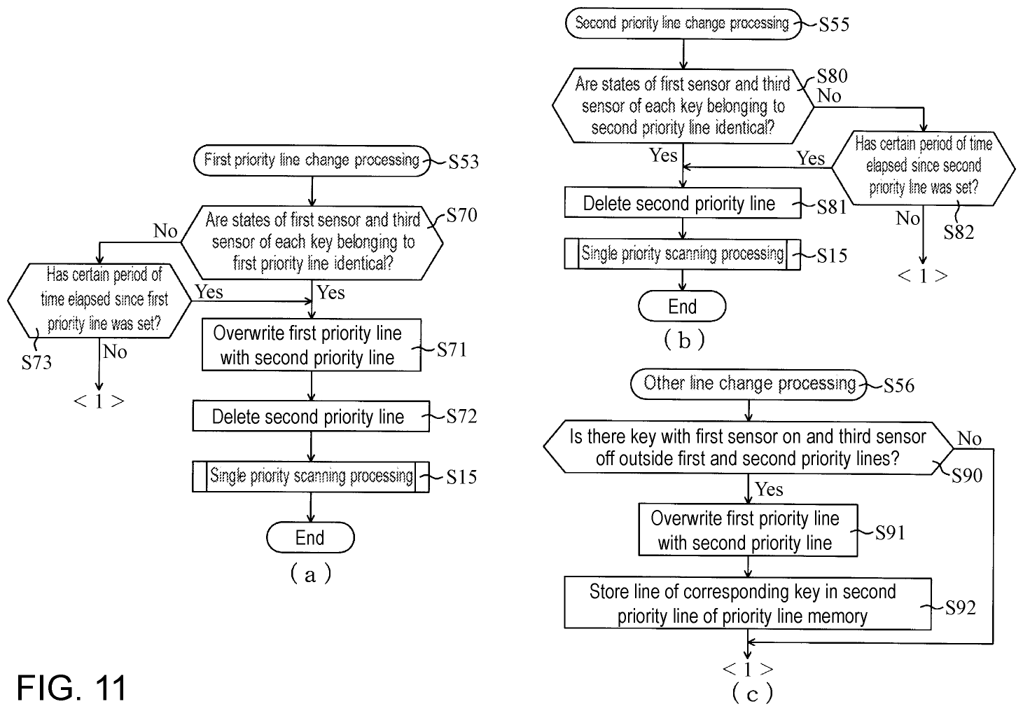

(c) of FIG. 8 is a flowchart of the velocity processing. The velocity processing is processing for calculating a velocity based on the detected state of the sensors 2eX and 2fX and controlling a musical tone based on the calculated velocity. In addition to being executed from the normal scanning processing of (a) of FIG. 8, the velocity processing may also be executed from single priority scanning processing described later in FIG. 9 or from multiple priority scanning processing described later in FIG. 10.

In the velocity processing, first, it is determined whether the second sensor 2eX is on and the third sensor 2fX is on (S20). Specifically, in the processing of S20, it is determined whether the third sensor 2fX has turned from off to on with the second sensor 2eX on, or whether the second sensor 2eX and the third sensor 2fX have turned from off to on together.

In the processing of S20, if the second sensor 2eX is on and the third sensor 2fX is on (S20: Yes), from a time difference between a time when the second sensor 2eX turned from off to on and a time when the third sensor 2fX turned from off to on, a velocity of the key 2aX is calculated (S21). After the processing of S21, a musical tone of the corresponding key 2aX is controlled using the calculated velocity. Specifically, for example, a volume level of the musical tone of the corresponding key 2aX is changed according to a magnitude of the calculated velocity.

In this way, in the present embodiment, the velocity is calculated based on the second sensor 2eX and the third sensor 2fX among the sensors 2dX to 2fX provided for each key 2aX. In the case where the second sensor 2eX is on, since the first sensor 2dX preceding the second sensor 2eX is on, a scan line to which the corresponding key 2aX belongs is set as the priority line. Thus, the frequency of detection of the corresponding second sensor 2eX and third sensor 2fX is high.

On the other hand, since the state of the first sensor 2dX may also be detected in the scan order SS (see (a) of FIG. 5) in which no priority line is set, there are also cases where the frequency of detection of the first sensor 2dX may be lower than the second sensor 2eX and the third sensor 2fX detected by the priority line. In this way, based on the state of the second sensor 2eX and the third sensor 2fX of which the frequency of detection is high, the frequency of calculation of the velocity is increased. Thus, a velocity closely following a depression or release operation on the corresponding key 2aX can be output.

For example, in the case where the key 2aX that has been depressed is released and then depressed again before being completely released, since the key 2aX is not completely released in a series of operations, the first sensor 2dX is in the on state even in the middle of key release. Thus, if the state of the first sensor 2dX is taken into consideration in velocity calculation, the velocity due to key release is affected by the first sensor 2dX that is on and the magnitude thereof will not be sufficiently decreased. Thus, since the volume of the musical tone is not sufficiently decreased by key release, even if the volume of the musical tone is returned to the state before key release by the second key depression after that, there is a possibility that the user H may hardly hear that the musical tone is output again (produced again).

Accordingly, by excluding the state of the first sensor 2dX from velocity calculation, both the second sensor 2eX and the third sensor 2fX are turned off by the previous key release. Thus, the velocity can be calculated to be sufficiently small. Since a difference between this velocity and the velocity before and after the previous key release is increased, a variation in the volume of the musical tone is increased. Thus, the musical tone can be appropriately produced again by key release and second key depression.

In the processing of S20, if the second sensor 2eX is on and the third sensor 2fX is not on (S20: No), or after the processing of S22, the velocity processing is ended.

Please refer back to (b) of FIG. 8. After the velocity processing of S12, it is determined whether there is a key 2aX with the first sensor 2dX on and the third sensor 2fX off (S13). In the processing of S13, it is determined whether the first sensor 2dX has turned from off to on with the third sensor 2fX off, that is, whether the corresponding key 2aX is depressed, or whether the third sensor 2fX has turned from on to off with the first sensor 2dX on, that is, whether the corresponding key 2aX is released. In other words, it is determined whether the corresponding key 2aX is in the middle of being depressed or being released.

In the processing of 513, if there is no key 2aX with the first sensor 2dX on and the third sensor 2fX off (S13: No), the processing of S11 onward is repeated. On the other hand, in the processing of S13, if there is a key 2aX with the first sensor 2dX on and the third sensor 2fX off (S13: Yes), a scan line to which the corresponding key 2aX belongs is stored in the first priority line 12b1 of the priority line memory 12b (S14). After the processing of S14, the single priority scanning processing (S15) is executed, and the normal scanning processing is ended. Here, the single priority scanning processing is described with reference to FIG. 9.

FIG. 9 is a flowchart of the single priority scanning processing. The single priority scanning processing is processing executed in the case where only the first priority line L1 is set as the priority line. In addition to being executed from the normal scanning processing of (a) of FIG. 8, the single priority scanning processing may also be executed from first priority line change processing described later in (a) of FIG. 11 or from second priority line change processing described later in (b) of FIG. 11.

In the single priority scanning processing, first, the scan order SS is set based on the time slot data TD of the time slot data 11b and the priority line memory 12b, and is stored in the scan order memory 12a (S30). In the processing of S30, since the second priority line 12b2 is not set while a scan line is set in the first priority line 12b1 of the priority line memory 12b, the scan order SS in which the time slot of the second priority line L2 and the time slot of the scan line corresponding to the first priority line L1 are deleted from the time slot data TD is stored in the scan order memory 12a.

After the processing of S30, the state of the sensors 2dX to 2fX of each key 2aX is detected based on the scan order SS of the scan order memory 12a (S31). After the processing of S31, the velocity processing of S12 described above in (c) of FIG. 8 is executed. After the velocity processing of S12, it is determined whether detection of the state of the sensors 2dX to 2fX of the first priority line L1 by the processing of S31 has been completed (S32).

In the processing of S32, if detection of the state of the sensors 2dX to 2fX of the first priority line L1 has been completed (S32: Yes), it is determined whether the states of the first sensor 2dX and the third sensor 2fX of each key 2aX belonging to the first priority line L1 are identical (S33). In the processing of S33, it is determined whether the states of the first sensor 2dX and the third sensor 2fX corresponding to the key 2aX belonging to the first priority line L1 are identical, that is, whether depression or release of the key 2aX belonging to the first priority line L1 has been completed.

In the processing of S33, if the states of the first sensor 2dX and the third sensor 2fX of each key 2aX belonging to the first priority line L1 are identical (S33: Yes), since depression or release of the key 2aX belonging to the corresponding scan line is completed and there is no need to increase the frequency of detection of the corresponding scan line, the first priority line 12bi of the priority line memory 12b is deleted, and the first priority line 12bi is rendered not set (S34).

After the processing of S34, the normal scanning processing of S2 described above in (b) of FIG. 8 is performed. Accordingly, a scan line in which depression or release of the key 2aX has been completed is removed from the first priority line L1, and detection of the state of the sensors 2dX to 2fX according to the scan order SS in which no priority line is set is executed.

In the processing of S33, if the states of the first sensor 2dX and the third sensor 2fX corresponding to the key 2aX belonging to the first priority line L1 are not identical (S33: No), it is determined whether a certain period of time (for example, 20 milliseconds) has elapsed since the first priority line L1 was set (S35). In the processing of S35, if a certain period of time (for example, 20 milliseconds) has elapsed since the first priority line L1 was set (S35: Yes), the processing of S34 and the velocity processing of S12 are executed.

That is, the first priority line L1 that was set a certain period of time ago includes the key 2aX that has been continuously depressed or released. Since such a key 2aX is slowly depressed or released, even without high-frequency detection by the first priority line L1, the state in the middle of key depression or key release can be followed by the scan order SS in which no priority line is set, as illustrated in (a) of FIG. 5. Accordingly, by deleting the first priority line L1 that was set a certain period of time ago, the state in the middle of key depression or key release of a scan line that was the first priority line L1 can be appropriately detected, and a scan line other than the aforesaid scan line can be set as the priority line.

In the processing of S32, if detection of the state of the sensors 2dX to 2fX of the first priority line L1 has not been completed (S32: No), detection of the state of the sensors 2dX to 2fX in a scan line other than the first priority line L1 may have been completed. In such a case, it is determined whether there is a key 2aX with the first sensor 2dX on and the third sensor 2fX off in the scan line other than the first priority line L1 (S36).

Similarly to the processing of S13, in the processing of S36, in the scan line other than the first priority line L1, it is determined whether the first sensor 2dX has turned from off to on with the third sensor 2fX off, that is, whether the corresponding key 2aX is depressed, or whether the third sensor 2fX has turned from on to off with the first sensor 2dX on, that is, whether the corresponding key 2aX is released.

In the processing of S36, if there is a key 2aX with the first sensor 2dX on and the third sensor 2fX off in the scan line other than the first priority line L1 (S36: Yes), the scan line to which the corresponding key 2aX belongs is stored in the second priority line 12b2 of the priority line memory 12b (S37). After the processing of S37, the multiple priority scanning processing of S38 is executed. The multiple priority scanning processing will be described later in FIG. 10 and FIG. 11.

In the processing of S35, if a certain period of time has not elapsed since the first priority line L1 was set (S35: No), or in the processing of S36, if there is no key 2aX with the first sensor 2dX on and the third sensor 2fX off in the scan line other than the first priority line L1 (S36: No), the processing of S31 onward is repeated.

After the normal scanning processing of S2 executed after the processing of S34, or after the multiple priority scanning processing of S38, the single priority scanning processing is ended.

Next, the multiple priority scanning processing of S38 is described with reference to FIG. 10 and FIG. 11. FIG. 10 is a flowchart of the multiple priority scanning processing. The multiple priority scanning processing is processing executed in the case where both the first priority line L1 and the second priority line L2 are set as the priority line.

In the multiple priority scanning processing, first, the scan order SS is set based on the time slot data TD of the time slot data 11b and the priority line memory 12b, and is stored in the scan order memory 12a (S50). In the processing of S50, since a scan line is set in each of the first priority line 12b1 and the second priority line 12b2 of the priority line memory 12b, the scan order SS in which the time slots of the scan lines corresponding to the first priority line L1 and the second priority line L2 are deleted from the time slot data TD, as illustrated in (c) of FIG. 5, is stored in the scan order memory 12a.

After the processing of S50, the state of the sensors 2dX to 2fX of each key 2aX is detected based on the scan order SS of the scan order memory 12a (S51). After the processing of S51, the velocity processing of S12 described above in (c) of FIG. 8 is executed. After the velocity processing of S12, it is determined whether detection of the state of the sensors 2dX to 2fX of the first priority line L1 by the processing of S51 has been completed (S52). In the processing of S52, if detection of the state of the sensors 2dX to 2fX of the first priority line L1 has been completed (S52: Yes), the first priority line change processing (S53) is executed. The first priority line change processing is described with reference to (a) of FIG. 11.

(a) of FIG. 11 is a flowchart of the first priority line change processing. In the first priority line change processing, first, it is determined whether the states of the first sensor 2dX and the third sensor 2fX of each key 2aX belonging to the first priority line L1 are identical (S70). Since the processing of S70 is the same as the processing of S33 described above in FIG. 9, a detailed description thereof is omitted.

In the processing of S70, if the states of the first sensor 2dX and the third sensor 2fX of each key 2aX belonging to the first priority line L1 are identical (S70: Yes), in order to delete the current first priority line L1 and set the current second priority line L2 as the first priority line L1, first, the second priority line 12b2 of the priority line memory 12b is overwritten (copied) to the first priority line 12b1 (S71). After the processing of S71, the second priority line 12b2 of the priority line memory 12b is deleted, and the second priority line 12b2 is rendered not set (S72). After the processing of S72, the single priority scanning processing of S15 described above in FIG. 9 is executed, and the first priority line change processing is ended.

On the other hand, in the processing of S70, if the states of the first sensor 2dX and the third sensor 2fX of each key 2aX belonging to the first priority line L1 are not identical (S70: No), it is determined whether a certain period of time has elapsed since the first priority line L1 was set (S73). Similarly, since the processing of S73 is the same as the processing of S35 described above in FIG. 9, a detailed description thereof is omitted.

In the processing of S73, if a certain period of time has elapsed since the first priority line L1 was set (S73: Yes), the processing of S71 onward is executed. If a certain period of time has not elapsed since the first priority line L1 was set (S73: No), the processing of S51 onward in FIG. 10 (that is, “<1>” onward in FIG. 10) is repeated.

Please refer back to FIG. 10. In the processing of S52, if detection of the state of the sensors 2dX to 2fX of the first priority line L1 has not been completed (S52: No), detection of the state of the sensors 2dX to 2fX in the scan line other than the first priority line L1 may have been completed. In such a case, it is determined whether detection of the state of the sensors 2dX to 2fX of the second priority line L2 has been completed (S54). In the processing of S54, if detection of the state of the sensors 2dX to 2fX of the second priority line L2 has been completed (S54: Yes), the second priority line change processing (S55) is executed. The second priority line change processing is described with reference to (b) of FIG. 11.

(b) of FIG. 11 is a flowchart of the second priority line change processing. In the second priority line change processing, first, it is determined whether the states of the first sensor 2dX and the third sensor 2fX of each key 2aX belonging to the second priority line L2 are identical (S80).

In the processing of S80, if the states of the first sensor 2dX and the third sensor 2fX of each key 2aX belonging to the second priority line L2 are identical (S80: Yes), the second priority line 12b2 of the priority line memory 12b is deleted, and the second priority line 12b2 is rendered not set (S81). After the processing of S81, the single priority scanning processing of S15 described above in FIG. 9 is executed, and the second priority line change processing is ended. Accordingly, a scan line in which depression or release of the key 2aX has been completed is deleted from the second priority line L2, and detection of the state of the sensors 2dX to 2fX by the scan order SS in which only the first priority line L1 is set is executed.

On the other hand, in the processing of S80, if the states of the first sensor 2dX and the third sensor 2fX of each key 2aX belonging to the second priority line L2 are not identical (S80: No), it is determined whether a certain period of time has elapsed since the second priority line L2 was set (S82).

In the processing of S82, if a certain period of time has elapsed since the second priority line L2 was set (S82: Yes), the processing of S81 onward is executed. If a certain period of time has not elapsed since the second priority line L2 was set (S82: No), the processing of S51 onward in FIG. 10 (that is, “<1>” onward in FIG. 10) is repeated.

Please refer back to FIG. 10. In the processing of S54, if detection of the state of the sensors 2dX to 2fX of the second priority line L2 has not been completed (S54: No), detection of the state of the sensors 2dX to 2fX in a scan line other than the first priority line L1 and the second priority line L2 may have been completed. In such a case, other line change processing of S56 is executed. The other line change processing is described with reference to (c) of FIG. 11.

(c) of FIG. 11 is a flowchart of the other line change processing. In the other line change processing, first, it is determined whether there is a key 2aX with the first sensor 2dX on and the third sensor 2fX off in the scan line other than the first priority line L1 and the second priority line L2 (S90). Similarly to the processing of S13 and S36, in the processing of S90, in the scan line other than the first priority line L1 and the second priority line L2, it is determined whether the first sensor 2dX has turned from off to on with the third sensor 2fX off, that is, whether the corresponding key 2aX is depressed, or whether the third sensor 2fX has turned from on to off with the first sensor 2dX on, that is, whether the corresponding key 2aX is released.

In the processing of S90, if there is a key 2aX with the first sensor 2dX on and the third sensor 2fX off in the scan line other than the first priority line L1 and the second priority line L2 (S90: Yes), the second priority line 12b2 of the priority line memory 12b is overwritten (copied) to the first priority line 12b1 (S91). After the processing of S91, a scan line to which the key 2aX with the first sensor 2dX on and the third sensor 2fX off belongs is stored in the second priority line 12b2 of the priority line memory 12b (S92).

Accordingly, among the first priority line L1 and the second priority line L2, the first priority line L1 that was earliest set as the priority line is deleted, and instead, the scan line to which the key 2aX with the first sensor 2dX on and the third sensor 2fX off belongs is newly set for priority scanning.

That is, the first priority line L1 that was earliest set as the priority line also includes the key 2aX that has been continuously depressed or released. Since such a key 2aX is slowly depressed or released, even without high-frequency detection by the first priority line L1, the state in the middle of key depression or key release can be followed by normal detection of the first to eleventh lines of the time slots TS1, TS3 or the like. Accordingly, by deleting the first priority line L1 that was earliest set as the priority line, the state in the middle of key depression or key release of a scan line that was the first priority line L1 can be appropriately detected, and the frequency of detecting the scan line that has newly become a priority line can be increased.

In the processing of S90, if there is no key 2aX with the first sensor 2dX on and the third sensor 2fX off in the scan line other than the first priority line L1 and the second priority line L2 (S90: No), or after the processing of S92, the processing of S51 onward in FIG. 10 (that is, “<1>” onward in FIG. 10) is repeated.

Please refer back to FIG. 10. After the first priority line change processing of S53, the second priority line change processing of S55, or the other line change processing of S56, the multiple priority scanning processing is ended.

Although the present disclosure has been described based on the above embodiment, it can be easily inferred that various improvements or modifications may be made.

In the above embodiment, the number of keys 2aX belonging to one scan line is 8. However, the present disclosure is not limited thereto. The number of keys 2aX belonging to one scan line may be 11 or more, or may be 11 or less. In particular, the number of keys 2aX included in one scan line may be one, and the state may be detected for each key 2aX. In this case, a priority line may also be set for each key 2aX.

A scan line may be composed of a set of keys 2aX having a musically common meaning. For example, the keys 2aX corresponding to the same octave, such as from certain “do” to the next “si”, may be configured as one scan line, or the keys 2aX corresponding to notes forming a chord such as “do-mi-so” may be configured as one scan line.

In the above embodiment, there are two priority lines, the first priority line L1 and the second priority line L2. However, the present disclosure is not limited thereto. There may be one priority line, or may be three or more priority lines. The number of priority lines is not necessarily fixed and may be variable. For example, the number of priority lines may be increased or decreased in accordance with a tempo of a musical piece played by the keyboard 2. In this case, if the musical piece played by the keyboard 2 has a slow tempo, the number of priority lines may be decreased (for example, decreased to one); if the musical piece is up-tempo, the number of priority lines may be increased (for example, increased to three).

The scan line to which the key 2aX that is in the middle of being depressed or being released belongs is set as the priority line. However, the present disclosure is not limited thereto. A certain scan line designated by the user H via the setting key 4 or the like may always be fixed as a priority scan line regardless of whether the key 2aX is in the middle of being depressed or being released.

Furthermore, musical score information (such as MIDI data) of a musical piece played by the user H may be acquired in advance, and based on the musical score information, a scan line to which the key 2aX scheduled to be depressed or released for each scene (timing) of performance of the user H may be sequentially set as the priority line.

Along with setting of a priority line or instead of setting of a priority line, the frequency of detection of a scan line among the first to eleventh lines of the time slots TS1, TS3, TS5 or the like of the time slot data TD to which the key 2aX that has not been depressed or released for a certain period of time (for example, three seconds) belongs may be reduced. In this case, addition of the corresponding scan line to the scan order SS may be omitted, or detection of the corresponding scan line in the scan order SS may be completely omitted, or detection of the corresponding scan line may be performed only once for each multiple times (for example, twice) of detection of the scan order SS. By omitting detection of the scan line that has not been depressed or released, the frequency of detection of other scan lines can be increased.

In the above embodiment, in the processing of S33 of FIG. 9, the processing of S73 of (a) of FIG. 11 and the processing of S82 of (b) of FIG. 11, when a certain period of time has elapsed since a certain scan line was set as the priority line, the scan line is excluded from the priority line. However, the present disclosure is not limited thereto. For example, the processing of S33 of FIG. 9 and so on may be omitted, and even after a certain period of time has elapsed since a certain scan line was set as the priority line, the scan line may remain the priority line until depression or release of the key 2aX is completed.

In the above embodiment, the first to eleventh lines are arranged in order in the time slot data TD. However, the present disclosure is not limited thereto. The first to eleventh lines may be arranged randomly in the time slot data TD. A configuration is also possible in which the user H is able to designate an arrangement of the first to eleventh lines in the time slot data TD via the setting key 4.

Furthermore, in one time slot data TD, the first to eleventh lines may be repeatedly arranged (for example, two time slots of the first line are arranged in the time slot data TD). For example, by repeatedly arranging a scan line including the key 2aX that is frequently depressed in the musical piece played by the keyboard 2 in the time slot data TD, the frequency of detection of the key 2aX can be increased together with the priority line.

In the above embodiment, the priority line is inserted between each of the first to eleventh lines in the time slot data TD. However, the present disclosure is not limited thereto. For example, in the time slot data TD, the first priority line L1 and the second priority line L2 in the priority lines may be arranged consecutively. A configuration is also possible in which the user H is able to designate an arrangement of the priority line in the time slot data TD via the setting key 4.

In the above embodiment, the electronic piano 1 is illustrated as an example of the electronic musical instrument. However, the present disclosure is not limited thereto, and may be applied to other electronic musical instruments such as an electronic organ or an electronic wind instrument. The control program 11a may be executed by an information processing device such as a personal computer or a portable terminal. In this case, the keyboard 2 may be connected to the information processing device such as a personal computer.

What is claimed is:

1. An electronic musical instrument comprising:
a plurality of keys;
a detection part, detecting, by a plurality of detectors provided for each of the keys, a state of depression or release of the key;
a musical tone controller, controlling a musical tone according to the state of the key detected by the detection part;
a scanning part, sequentially executing detection of the state of the key by the detection part for each of the keys;
an operation key acquisition part, acquiring the key that is in the middle of being depressed or being released based on a detection result obtained by the detection part; and
a priority part, giving priority to the detection of the state of the key acquired by the operation key acquisition part by the detection part in the scanning part.

2. The electronic musical instrument according to claim 1, wherein
the scanning part executes the detection of the state of the key by the detection part in a scan order that is an order of the key whose state is detected by the detection part; and
the priority part inserts the key acquired by the operation key acquisition part into the scan order, thereby giving priority to the detection of the state of the key by the detection part.

3. The electronic musical instrument according to claim 2, wherein
the priority part inserts the key acquired by the operation key acquisition part into an insertion position that is a predetermined position of the key in the scan order.

4. The electronic musical instrument according to claim 3, wherein
the priority part, in response to presence of the key acquired by the operation key acquisition part before or after the insertion position in the scan order, inserts the key into the insertion position in the scan order and deletes the key before or after the insertion position from the scan order.

5. The electronic musical instrument according to claim 3, wherein
the priority part sequentially inserts a plurality of keys acquired by the operation key acquisition part into the scan order, and, in response to number of the keys inserted into the scan order reaching or exceeding a predetermined number, deletes the key that was earliest inserted from the insertion position in the scan order.

6. The electronic musical instrument according to claim 3, wherein
the priority part sequentially inserts a plurality of keys acquired by the operation key acquisition part into the scan order, and, in response to an elapse of a predetermined time since the key was inserted into the insertion position in the scan order, deletes the key from the insertion position in the scan order.

7. The electronic musical instrument according to claim 1, wherein
the plurality of keys are divided into scan lines by a predetermined number;
the detection part, for each of the scan lines, detects the state of the key belonging to the scan line;
the scanning part sequentially executes detection of the state by the detection part for each of the scan lines; and
the priority part gives priority to the detection of the state of the scan line to which the key acquired by the operation key acquisition part belongs by the detection part.

8. The electronic musical instrument according to claim 1, wherein
at least three of the detectors are arranged so as to sequentially turn on or off according to a stage of depression or release of the key;
in a case where the key in a released state is depressed, among the plurality of detectors, a first detector turns on in the stage in which a position of the key is shallowest, a second detector turns on in the stage in which the position of the key is second shallowest, and a third detector turns on in the stage in which the position of the key is third shallowest; and
the operation key acquisition part acquires the key with the first sensor on and the third sensor off as the key that is in the middle of being depressed or being released.

9. The electronic musical instrument according to claim 8, wherein,
according to a state of the second detector or the detector that turns on in the stage in which the position of the key is deeper than that of the second detector, the musical tone controller controls the musical tone corresponding to the key.

10. The electronic musical instrument according to claim 9, wherein
the musical tone controller calculates a velocity of the musical tone of the key according to a timing at which the second detector turns on or the detector that turns on in the stage in which the position of the key is deeper than that of the second detector turns on.

11. A key scanning method, executed by an electronic musical instrument provided with a plurality of keys and a plurality of detectors provided for each of the keys, wherein the key scanning method comprises:
a detection step of detecting a state of depression or release of the key by the detector;
a musical tone control step of controlling a musical tone according to the state of the key detected by the detection step;
a scanning step of sequentially executing detection of the state of the key by the detection step for each of the keys;
an operation key acquisition step of acquiring the key that is in the middle of being depressed or being released based on a detection result obtained by the detection step; and
a priority step of giving priority to the detection of the state of the key acquired by the operation key acquisition step by the detection step in the scanning step.

12. The key scanning method according to claim 11, wherein
the scanning step comprises executing the detection of the state of the key by the detection step in a scan order that is an order of the key whose state is detected by the detection step; and
the priority step comprises inserting the key acquired by the operation key acquisition step into the scan order, thereby giving priority to the detection of the state of the key by the detection step.

13. The key scanning method according to claim 12, wherein
the priority step comprises inserting the key acquired by the operation key acquisition step into an insertion position that is a predetermined position of the key in the scan order.

14. The key scanning method according to claim 13, wherein
the priority step comprises, in response to presence of the key acquired by the operation key acquisition step before or after the insertion position in the scan order, inserting the key into the insertion position in the scan order and deleting the key before or after the insertion position from the scan order.

15. The key scanning method according to claim 13, wherein
the priority step comprises sequentially inserting a plurality of keys acquired by the operation key acquisition step into the scan order, and, in response to number of the keys inserted into the scan order reaching or exceeding a predetermined number, deleting the key that was earliest inserted from the insertion position in the scan order.

16. The key scanning method according to claim 13, wherein
the priority step comprises sequentially inserting a plurality of keys acquired by the operation key acquisition step into the scan order, and, in response to an elapse of a predetermined time since the key was inserted into the insertion position in the scan order, deleting the key from the insertion position in the scan order.

17. The key scanning method according to claim 11, wherein
the plurality of keys are divided into scan lines by a predetermined number;
the detection step comprises, for each of the scan lines, detecting the state of the key belonging to the scan line;
the scanning step comprises sequentially executing detection of the state by the detection step for each of the scan lines; and
the priority step comprises giving priority to the detection of the state of the scan line to which the key acquired by the operation key acquisition step belongs by the detection step.

18. The key scanning method according to claim 11, wherein
at least three of the detectors are arranged so as to sequentially turn on or off according to a stage of depression or release of the key;
in a case where the key in a released state is depressed, among the plurality of detectors, a first detector turns on in the stage in which a position of the key is shallowest, a second detector turns on in the stage in which the position of the key is second shallowest, and a third detector turns on in the stage in which the position of the key is third shallowest; and
the operation key acquisition step comprises acquiring the key with the first sensor on and the third sensor off as the key that is in the middle of being depressed or being released.

19. The key scanning method according to claim 18, wherein
the musical tone control step comprises, according to a state of the second detector or the detector that turns on in the stage in which the position of the key is deeper than that of the second detector, controlling the musical tone corresponding to the key.

20. A non-transitory computer readable medium, storing a key scanning program causing a computer provided with a keyboard that comprises a plurality of keys and a plurality of detectors provided for each of the keys to execute processing for sequentially detecting a state of the key, wherein the key scanning program causes the computer to execute:
a detection step of detecting a state of depression or release of the key by the detector;
a musical tone control step of controlling a musical tone according to the state of the key detected by the detection step;
a scanning step of sequentially executing detection of the state of the key by the detection step for each of the keys;
an operation key acquisition step of acquiring the key that is in the middle of being depressed or being released based on a detection result obtained by the detection step; and
a priority step of giving priority to the detection of the state of the key acquired by the operation key acquisition step by the detection step in the scanning step.
